(19) United States
(12) Patent Application Publication
(10) Pub. No.: US 2022/0230079 A1
(43) Pub. Date: Jul. 21, 2022

(54) ACTION RECOGNITION

(71) Applicant: Microsoft Technology Licensing, LLC, Redmond, WA (US)

(72) Inventors: Bugra TEKÍN, Kilchberg (CH); Marc POLLEFEYS, Zurich (CH); Federica BOGO, Kilchberg (CH)

(21) Appl. No.: 17/155,013

(22) Filed: Jan. 21, 2021

(51) Int. Cl. G06N 5/04; G06F 3/01; G06N 20/00

(52) U.S. Cl. CPC G06N 5/04; G06N 20/00; G06F 3/012; G06F 3/013

(57) ABSTRACT

In various examples there is an apparatus with at least one processor and a memory storing instructions that, when executed by the at least one processor, perform a method for recognizing an action of a user. The method comprises accessing at least one stream of pose data derived from captured sensor data depicting the user; sending the pose data to a machine learning system having been trained to recognize actions from pose data; and receiving at least one recognized action from the machine learning system.

### BACKGROUND

Whilst image processing to recognize objects is a relatively well developed area of technology, recognition of actions remains a challenging field. A non-exclusive list of examples of actions is: pick up jar, put jar, take spoon, open jar, scoop spoon, pour spoon, stir spoon.

The embodiments described below are not limited to implementations which solve any or all of the disadvantages of known action recognition systems.

### SUMMARY

The following presents a simplified summary of the disclosure in order to provide a basic understanding to the reader. This summary is not intended to identify key features or essential features of the claimed subject matter nor is it intended to be used to limit the scope of the claimed subject matter. Its sole purpose is to present a selection of concepts disclosed herein in a simplified form as a prelude to the more detailed description that is presented later.

In various examples there is an apparatus with at least one processor and a memory storing instructions that, when executed by the at least one processor, perform a method for recognizing an action of a user. The method comprises accessing at least one stream of pose data derived from captured sensor data depicting the user; sending the pose data to a machine learning system having been trained to recognize actions from pose data; and receiving at least one recognized action from the machine learning system.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a schematic diagram of an action recognition system in use;

FIG. 2 is a schematic diagram of an action and of pose data associated with the action;

FIG. 3 is a flow diagram of a method of action recognition;

FIG. 4 shows a normalization component;

FIG. 5 shows a plurality of action recognition models for different scenarios;

FIG. 6 is a flow diagram of a method of training a plurality of action recognition models;

FIG. 7 illustrates an exemplary computing-based device in which embodiments of an action recognition system are implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present examples are constructed or utilized. The description sets forth the functions of the examples and the sequence of operations for constructing and operating the examples. However, the same or equivalent functions and sequences may be accomplished by different examples.

Image processing technology including use of deep neural networks to recognize objects depicted in images and videos is known. However, the task of action recognition remains a challenge. Actions carried out by a user or other person, animal, or robot span a huge range of types of action. Many, but not all, of these actions involve hand-eye co-ordination on the part of a user. In some cases, such as playing sports, hands are not involved in an action whereas other body parts are such as the lower leg and foot in the case of football, or the whole body such as in the case of golf.

Action recognition is useful for a variety of purposes such as automated task guidance, risk avoidance, creating richer mixed-reality experiences and more. Consider first line workers such as engineers maintaining factory equipment, plumbers maintaining boilers, underground water pipe maintenance operatives, nurses, and others. By recognizing actions carried out by first line workers it is possible to automatically guide first line workers through steps of their complete task and thus provide training, task guidance and assistance.

There are a huge number of challenges involved with action recognition. One of the main challenges is the lack of datasets for training suitable machine learning models. To train machine learning models to recognize user actions, one would need to collect a large dataset that covers many different action types. Such datasets for generic action recognition do not exist yet. For example, there is no equivalent to the well-known ImageNet dataset, which is for object recognition, for action recognition.

Another challenge is the variability in how people perform the same actions. A first user might pick up a jar in a fast confident manner by gripping the jar body whilst another user might be hesitant, have a slight tremor, and pick up the jar by its lid. There is also variability in the environment in which the action is being performed such as the lighting and what clothing the user is wearing. Other sources of variability include occlusions. Self-occlusions happen where the user occludes some or part of the action him or herself, perhaps by one hand obscuring another. Other types of occlusion occur due to other users or other objects being in the environment. Fast camera motion is another source of variability. Fast camera motion occurs particularly in the case of fast actions such as playing a fast piano piece, waving a hand, making a golf swing.

Another challenge concerns the volume of data to be processed, which in the case of action recognition is potentially vast, since even more data needs to be processed than for the case of object recognition from images since an action occurs over a period of time longer than that when a single image is captured. However, in order to use action recognition data for automated task guidance, risk avoidance and the like, it is desirable to achieve action recognition in real time. Thus scalability is a significant challenge.

When recognizing actions, a significant amount of research and development has focused on image-based methods, in which a color or depth image is typically used as input to a machine learning model that classifies the type of action the person is doing. Such image-based methods suffer from inefficient runtimes and they require large amounts of data to perform reasonably and generalize well to unseen environments. Moreover, the training of such machine learning models typically takes a very long time, which hinders their practical application.

Previous work has further focused on using skeletal information (e.g. body or hand skeleton) for recognizing actions. This has shown benefits in reducing the computational complexity of the machine learning models. However, such methods ignore interactions with the physical world and are often inaccurate.

Another challenge regarding recognizing actions, is that typically the actions are to be recognized using resource constrained devices such as wearable computers or other mobile computing devices which are simple to deploy in environments where users are working. In the case of front line workers the working environment may be outdoors, in a building site, close to heavy machinery, in a warehouse or other environment where it is not practical to install fixed computing equipment or large resource computing equipment.

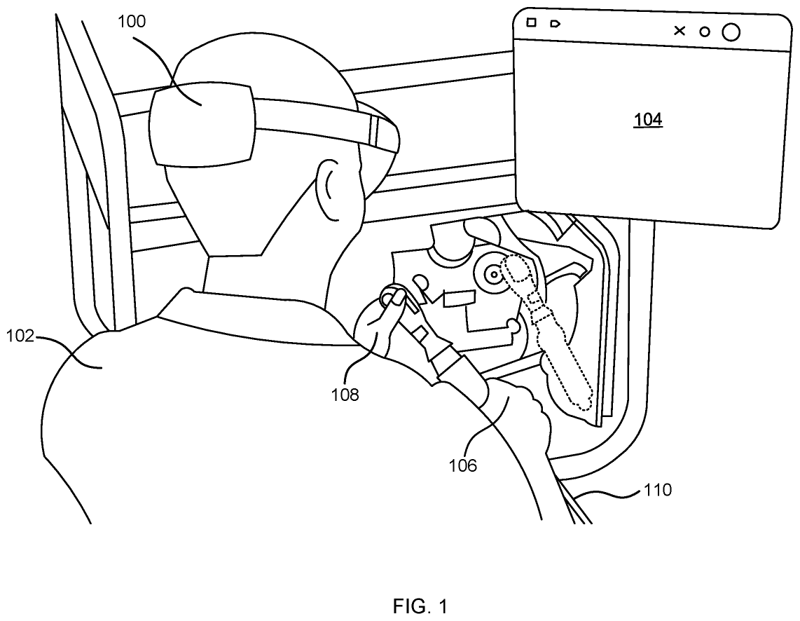

FIG. 1 is a schematic diagram of an action recognition system in use. The action recognition system is either deployed in a wearable computing device 100, in the cloud, or in a computing device which is in proximity to the wearable computing device 100, such as a desktop PC or laptop computer. A user 102 wears the wearable computing device 100 which in this example is a head worn augmented reality computing device which is displaying a hologram 104 to the wearer. The hologram depicts a video display with instructions (not visible) to guide the user with a task. The user is maintaining an apparatus using a tool 110. The user is holding the tool 110 with his or her hands 106, 108 and is able to see a hologram indicating where to place the tool for engaging with the apparatus. The dotted lines indicate the hologram indicating where to place the tool. The action recognition system is able to recognize an action the user 102 makes. The recognized action is then used to give feedback to the user 102 about his or her performance of the task, to trigger an alert if the action is incorrect or unsafe, to train the user 102, to retrieve information about the action or a task associated with the action and present the information at the hologram video display, or for other purposes.

The head worn computing device is a Microsoft HoloLens (trademark) or any other suitable head worn computing device giving augmented reality function. The head worn computing device comprises a plurality of sensors which capture data depicting the user and/or the environment of the user. The sensor data is processed by the head worn computing device to produce one or more streams of pose data. The term “pose” means 3D position and orientation. The pose data is sent to a machine learning system which predicts an action label for individual frames of the pose data.

The inventors have found that the action recognition system gives good results even where pose data is used rather than image data. By using pose data rather than image data the action recognition system is operable in real time, even for resource constrained deployments such as the wearable computing device (since pose data is much smaller in size per frame than image data).

Another benefit of using pose data rather than image data is that the action recognition system works well despite changes in lighting conditions, changes in clothing worn by users and other changes in the environment.

The pose data is derived from sensor data captured using sensors in the head worn computing device and/or in the environment such as mounted on a wall or equipment. The sensor data comprises one or more of: color video, depth images, infra-red eye gaze images, inertial measurement unit data, and more. In some cases audio data is sensed although not for computing pose from. In situations where the sensor data is from a plurality of different types of sensors (referred to as multi-modal sensor data) the sensor data from the difference sensors is to be synchronized. In embodiments where Microsoft HoloLens is used to obtain the sensor data the synchronization is achieved in a known manner using the HoloLens device.

Well known technology is used to derive the pose data from the captured sensor data.

In an example, to derive hand pose data, a 3D model of a generic hand is known in advance and is used to render images by using conventional ray tracing technology. The rendered images are compared to the observed images depicting the user's hand and a difference is found. Using an optimizer, values of pose parameters of the 3D model are adjusted so as to reduce the difference and fit the 3D model to the observed data. Once a good fit has been found the values of the pose of the real hand are taken to be the values of the parameters of the fitted 3D model. A similar process is useable to derive pose data of other body parts such as the face, the head, the leg, an eye, the whole body. The pose parameters of the 3D model comprise at least 3D position and orientation, so as to be a 6 degree of freedom pose. In the case of articulated body parts such as hands, the pose parameters optionally comprise joint positions of one or more joints in addition to the position and orientation. The joint positions are derived from the sensor data using model fitting as described above.

Eye pose is a direction and origin of a single eye gaze ray. The eye gaze ray is computed using well known technology whereby infra-red images of the eyes are obtained using accompanying light emitting diodes (LEDs) and used to compute the eye gaze.

In summary, the action recognition system is able to access at least one stream of pose data derived from captured sensor data depicting the user. The action recognition system sends the pose data to a machine learning system having been trained to recognize actions from pose data; and receives at least one recognized action from the machine learning system. To send the pose data to the machine learning system the action recognition system uses a wireless connection or other suitable connection to the machine learning system in the cloud or at any computing entity. In some cases the action recognition system sends the pose data over a local connection to the machine learning system which is integral with a wearable computer or other mobile computing device. In an example, the action recognition system accesses a plurality of streams of pose data derived from captured sensor data depicting the user. Individual ones of the streams depict an individual body part of the user and/or are expressed in different coordinate systems.

By using pose data the action recognition system of the disclosure operates in an unconventional manner to recognize actions, for example, in real time even where the action recognition system is deployed in a resource constrained device.

Using pose data improves the functioning of the underlying computing device by enabling fast and accurate action recognition.

The action recognition system is trained to recognize actions of a specified scenario in some examples. A scenario is a sequence of specified actions. A scenario is sometimes, but not always, associated with a particular type of object or a particular type of physical location. By training an action recognition system to recognize actions of a specified scenario good working results are obtained as evidenced in more detail below with empirical results.

An example of a scenario is “printer cartridge placement”. The printer cartridge placement scenario is defined as comprising seven possible actions as follows: opening printer lid, opening cartridge lid, taking cartridge, placing cartridge, closing cartridge lid, closing printer lid, and a seventh action “idle” where the user is not taking any action. The scenario “printer cartridge placement” is associated with an object which is a printer, and or a printer cartridge. The scenario “printer cartridge” is sometimes associated with a physical location which is a known location of a printer.

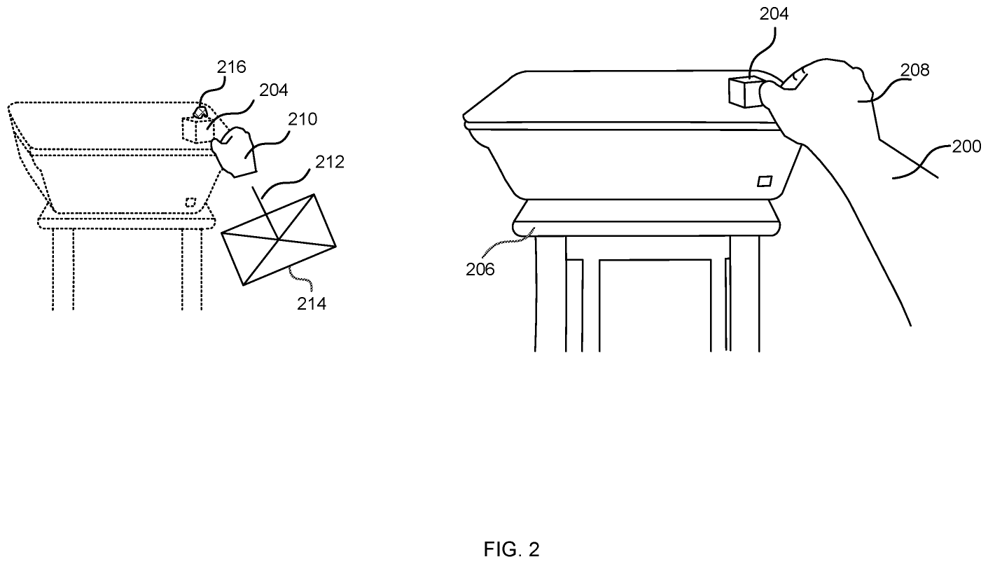

FIG. 2 shows an example of the action “taking cartridge” from the scenario “printer cartridge placement”. On the right hand side of FIG. 2 there is a scene comprising a printer supported on a table 206. On top of the printer is a cartridge 204. A user is reaching to pick up the cartridge 204 as indicated by the user's hand 208 and forearm 200. On the left hand side of FIG. 2 there is a schematic representation of a scene reconstruction (shown in dotted lines) generated from sensor data depicting the scene such as sensor data collected by an augmented reality computing device worn by the user. The scene reconstruction is not essential for the action recognition and is given in FIG. 2 to aid understanding of the technology.

Pose data has been derived from the sensor data as described above. The pose data comprises pose of the user's hand depicted schematically as icon 210 in FIG. 2. The pose data also includes a gaze position of the user indicated as gaze position 216 in FIG. 2 which is on top of the printer cartridge. The pose data also includes a gaze direction indicated by line 212 travelling away from a camera frustum 214 towards the gaze position 216. The gaze position 216 is part of the pose data.

FIG. 2 shows the situation at a particular point in time whereas the pose data in practice is two streams of pose data (one stream of hand pose data and one stream of eye gaze direction and eye gaze location data). A stream of pose data is considered as being made up of a sequence of frames, where a frame of pose data is pose data computed for a particular frame of captured sensor data.

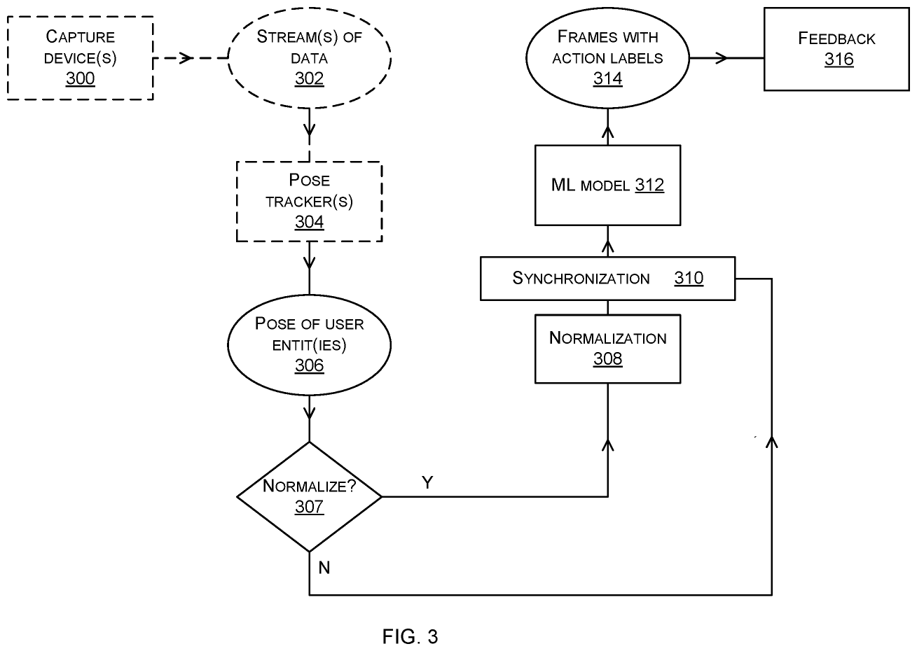

FIG. 3 shows, using the elements in solid lines, a method of operation at an action recognition system. The elements in dotted lines occur prior to operation of the action recognition system and are not essential parts of the action recognition system.

One or more capture devices 300 capture sensor data depicting a user in an environment. The capture devices 300 are cameras, depth sensors, inertial measurement units, global positioning systems, or other sensors. Streams 302 of sensed data are sent from the capture devices 300 into one or more pose trackers 304. A non-exhaustive list of the pose trackers 304 is: a head pose tracker, a hand pose tracker, an eye pose tracker, a body pose tracker. One or more streams 306 of pose data are output from the pose tracker(s) 304. An individual stream of pose data has pose data computed with respect to a specified coordinate system. The specified coordinate systems of the individual streams of pose data are not necessarily the same and typically are different from one another. A pose tracker 304 is typically a model fitter, or deep neural network, or other machine learning model which uses a world coordinate system. A world coordinate system is an arbitrary coordinate system specified for the particular pose tracker. The world coordinate systems of the various pose trackers are potentially different from one another.

The inventors have found that normalizing the pose data, by transforming all the pose data to a single coordinate system, has a significant effect on accuracy of the action recognition system. However, it is not essential to normalize the pose data.

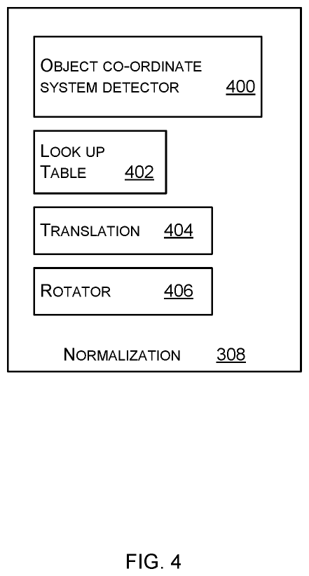

The action recognition system makes a decision 307 whether to normalize the pose data or not. The decision is made based on one or more factors comprising one or more of: the available types of pose data, a scenario. For example, if the available types of pose data are known to give good working results without normalization then normalization is not selected. If the available types of pose data are known to give more accurate action recognition results with normalization then normalization is used. In various examples, when the action to be recognized is associated with a physical location, normalization is useful and otherwise is not used. More detail about how normalization is achieved is given with reference to FIG. 4 later in this document.

Once the streams of pose data have been normalized at operation 308 the streams are synchronized 310 if necessary in order to align frames of pose data between the streams chronologically using time stamps of the frames. If normalization is not selected at decision 307 the process moves to operation 310.

Frames of the pose data (which may have been normalized at this point) is sent to a machine learning model 312. The machine learning model has been trained to recognize actions from pose data and it processes the frames of pose data and computes predicted action labels. The machine learning model outputs frames of pose data with associated action labels 314 which are stored. The frames of pose data with action labels 314 are used to give feedback to the user or for other purposes.

The machine learning model is any suitable machine learning classifier such as a random decision forest, neural network, support vector machine or other type of machine learning classifier. Recurrent neural networks and transformer neural networks are found to be particularly effective since these deal well with sequences of data such as the streams of pose data. A recurrent neural network is a class of deep neural networks where connections between nodes form a directed graph that allows to encode temporal dynamic behavior. A transformer neural network is a class of deep neural networks that consists of a set of encoding and decoding layers that process the input sequence iteratively one layer after another with a so-called “attention” mechanism. This mechanism weighs the relevance of every other input and draws information from them accordingly to produce the output.

More detail about normalization of pose data is now given with reference to FIG. 4 which shows a normalization component 308 of an action recognition system. The normalization component 308 has an object coordinate system detector 400, a look up table 402, a translation function 404 and a rotator function 406.

The normalization component 308 selects a common coordinate system to which the pose data is to be normalized by mapping the pose data into the common coordinate system. To select the common coordinate system a visual code such as a two dimensional bar code (for example, a quick response (QR) code) is used in some cases. The two dimensional bar code, such as a QR code, is physically located in the user's environment. An image of the two dimensional bar code is captured, by the wearable computing device or by another capture device, and used to retrieve a common coordinate system to be used. For example, the common coordinate system is found from a remote entity having an address specified by a visual code obtained from sensor data depicting an environment of the user. Alternatively, the normalization component 308 has a look up table 402 which is used to look up the visual code and retrieve a common coordinate system associated with the visual code.

To select the common coordinate system an object coordinate system detector 400 is used in some cases. The captured data of the user's environment depicts one or more objects in the environment such as a printer as in the example of FIG. 2. The object coordinate system detector 400 detects a coordinate system of the printer and the coordinate system of the printer is used as the common coordinate system of the normalization process. The object coordinate system detector comprises a 3D model of the object which is available in advance. The object coordinate system fits the 3D model of the object to the captured sensor data in order to compute a pose of the object. Once the pose of the object has been computed the pose is applied to the 3D model and an object coordinate system defined with respect to a centre of the 3D model. Obtaining the common coordinate system by accessing an object coordinate system of an object in an environment of the user is an effective way of selecting a common coordinate system which is found to work well in practice.

Once a common coordinate system has been selected the pose data is mapped to the common coordinate system by translation 404 and rotation 406 according to standard geometric methods.

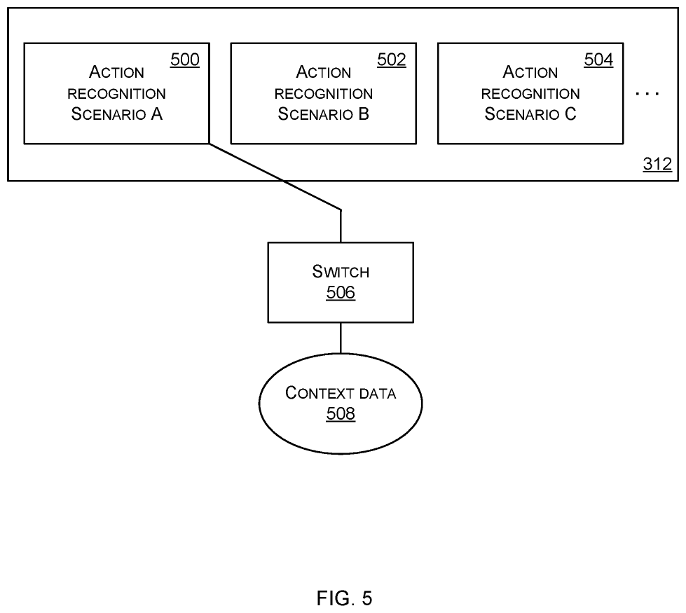

FIG. 5 shows a plurality of machine learning models 500, 502, 504 for different scenarios. Machine learning model 500 has been trained to recognize actions of scenario A, machine learning model 502 has been trained to recognize actions of scenario B, machine learning model has been trained to recognize actions of scenario C and so on for more machine learning models. The action recognition system switches between the machine learning models using switch 506, in response to context data. The context data 508 is obtained from the captured sensor data or from other sources. A non-exhaustive list of examples of context data 508 is: time of day, geographical location of the user from global positioning system data, a verbal command, a calendar entry.

By using a plurality of machine learning models as indicated in FIG. 5 it is possible to obtain an action recognition system which recognizes a range of actions for which training data is available, whilst still having good performance.

Alternatively or in addition, the functionality of the normalization component 308 and/or the machine learning models described herein is performed, at least in part, by one or more hardware logic components. For example, and without limitation, illustrative types of hardware logic components that are optionally used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), Graphics Processing Units (GPUs), artificial intelligence accelerator.

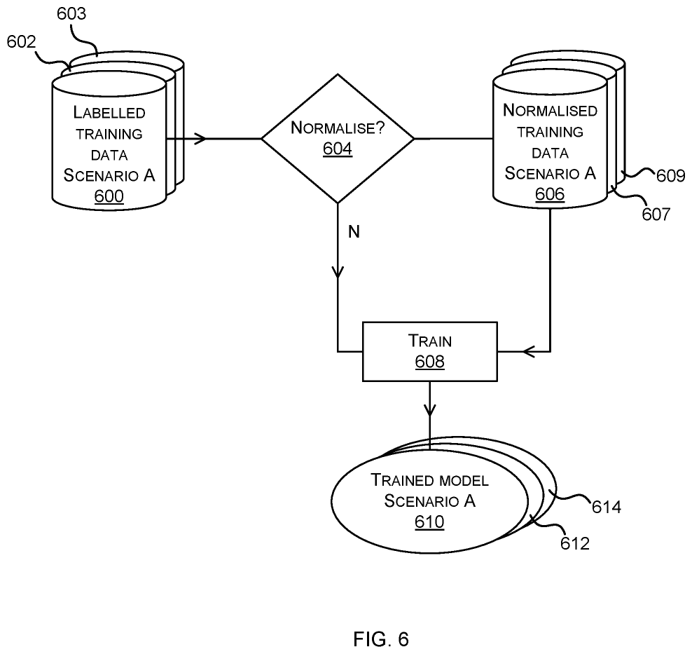

A method of training a machine learning model for action recognition is now described with reference to FIG. 6.

Training data is accessed from one or more stores 600, 602, 603. The training data comprises streams of recorded pose data which are labelled. The pose data is computed by one or more pose trackers as described above from captured sensor data depicting the user in an environment. The pose data is divided into frames and associated with each frame is a label indicating one of a plurality of possible actions. The labels are applied by human judges. The human judges view video frames associated with the pose frames and assess what action is being depicted in the video frame in order to apply a label. The training data is separated by scenario such as a store 600 of training data for scenario A, a store 602 of training data for scenario B and a store of training data for scenario C.

A decision is made as to whether normalization will be used or not. The decision is made according to the types of pose data available and the scenario. If normalization is not to be used during training or during inference (FIG. 3 shows the inference process) then the process moves to operation 608 at which the machine learning model is trained. The machine learning model is trained using supervised machine learning whereby individual training instances from the same scenario are processed by the model to compute a prediction. The error between the prediction and the label known for the training instance from the training data is computed. Parameters of the model are updated in order to reduce the error and the process repeats for more training instances until the training instance are used and/or until convergence is reached where there is little change in the weights. The result is a separate trained machine learning model 610, 612, 614 for each scenario. Note that the trained machine learning models are to be used with pose data that have not been normalized in the process of FIG. 3.

If normalization is to be used, a common coordinate system is selected or defined by the manufacturer. The labelled training data from the stores 600, 602, 603 is normalized by mapping it to the common coordinate system to create normalized training data in stores 606, 607, 609. The normalized training data retains the labels which were applied by the human judges.

The training operation 608 is carried out using the normalized training data and supervised learning as described above and produces a separate trained machine learning model for each scenario. Note that the machine learning models are to be used with normalized pose data during the process of FIG. 3.

In another embodiment, the machine learning system is trained with an additional type of data as well as pose data. The additional type of data is audio data. In this case, a plurality of the labelled training instance comprise pose data and audio data. The training proceeds as described above. It is found that including audio data improves accuracy of action recognition for many types of action which involve sounds such as closing a printer lid. Once the machine learning model has been trained, it is used to recognize actions by sending pose data and audio data to the trained model.

In another embodiment, the machine learning system is trained with one or more additional types of data as well as pose data. The one or more additional types of data are selected from one or more of: depth data, red green blue (RGB) video data, audio data.

In an embodiment the machine learning model is a transformer neural network or a spatiotemporal graph convolutional network, or a recurrent neural network. Such neural networks are examples of types of neural networks that are able to process sequential or time series data. Given that the pose data is sequence data, these types of neural network are well suited and are usable within the methods and apparatus described herein.

The inventors have carried out empirical testing and found the following results. The empirical results taken together with the theoretical reasons explained herein demonstrate that the technology is workable over a range of different machine learning model architectures, supervised training algorithms and labelled training data sets.

The empirical testing was carried out where the machine learning model is a recurrent neural network (RNN). It consists of 2 gated recurrent unit (GRU) layers of size 256 and a linear layer mapping the output of GRU layers to the outputs. Finally, a softmax operation is applied on the output of the network to compute action class probabilities. The recurrent neural network is trained for the “cartridge placement” scenario part of which is illustrated in FIG. 2. For this scenario, a training dataset consisting of 7 different output labels: “Idle”, “Opening Printer Lid”, “Opening Cartridge Lid”, “Taking Cartridge”, “Placing Cartridge”, “Closing Cartridge Lid”, “Closing Printer Lid” was obtained. The training data consists of 14 sequences and the validation data consists of 2 sequences acquired by HoloLens. The total number of frames of hand/head/eye pose data is 12698 for the training data, and 1616 for the test data. The training is based on the well-known Adam optimization with a learning rate of 0.001. The model was trained with a batch size of 1 for 200 epochs. The following results were obtained for the case with normalization with respect to an object coordinate system of the printer, and the case with no normalization. Results are shown for different pose data input stream(s) as indicated.

| | | Action Recognition |
|---|---|---|
| | | Accuracy in % |
| | | (pose normalized with |
| | Action Recognition | respect to an object |
| Pose data | Accuracy in % | coordinate system of |
| stream(s) | (No normalization) | the printer) |
| Hand | 71.63 | 80.86 |
| Head | 29.53 | 30.45 |
| Eye | 52.76 | 52.14 |
| Hand + Head | 67.92 | 86.11 |
| Hand + Eye | 64.05 | 87.16 |
| Head + Eye | 54.53 | 54.98 |
| Hand + Head + | 78.09 | 89.44 |
| Eye | | |

The empirical results demonstrate that accuracy of action recognition was increased by normalizing the pose data for every combination of pose data which was tested. The increase in accuracy was particularly good for the following combinations of pose data: hand and head, hand and eye, hand and head and eye.

The results unexpectedly show that action recognition accuracy was high in the case where hand pose was used alone either with or without normalization.

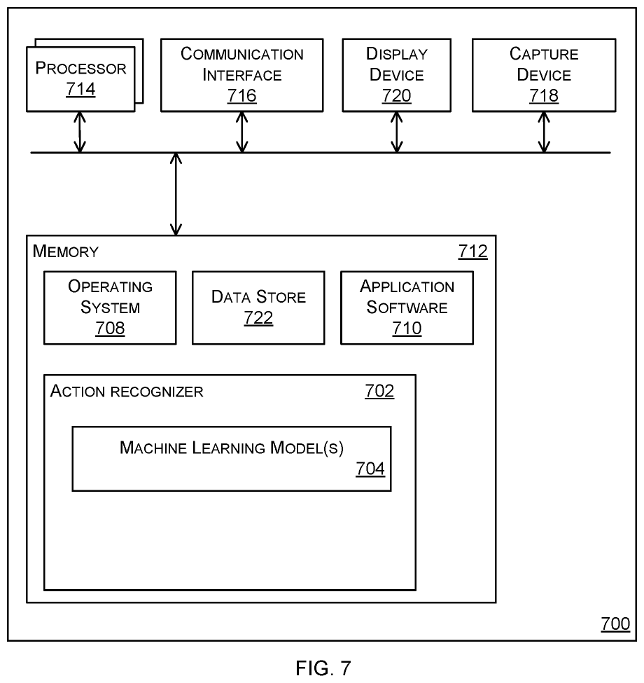

FIG. 7 illustrates various components of an exemplary computing-based device 700 which are implemented as any form of a computing and/or electronic device, and in which embodiments of an action recognition system are implemented in some examples. The computing-based device 700 is a wearable augmented reality computing device in some cases. The computing-based device 700 is a web server or cloud compute node in cases where the action recognition system is deployed as a cloud service, in which case the capture device 718 of FIG. 7 is omitted. The computing-based device 700 is a smart phone in some embodiments. The computing-based device 700 is a wall mounted computing device or other computing device fixed in an environment of the user in some embodiments.

Computing-based device 700 comprises one or more processors 714 which are microprocessors, controllers or any other suitable type of processors for processing computer executable instructions to control the operation of the device in order to recognize actions. In some examples, for example where a system on a chip architecture is used, the processors 714 include one or more fixed function blocks (also referred to as accelerators) which implement a part of the method of action recognition in hardware (rather than software or firmware). Platform software comprising an operating system 708 or any other suitable platform software is provided at the computing-based device to enable application software 710 to be executed on the device, such as application software 710 for guiding a user through a scenario. A data store 722 at a memory 712 of the computing-based device 700 holds action classes, labelled training data, pose data and other information. An action recognizer 702 at the computing-based device implements the process of FIG. 3 and optionally comprises a plurality of machine learning models 704 for different scenarios.

The computer executable instructions are provided using any computer-readable media that is accessible by computing based device 700. Computer-readable media includes, for example, computer storage media such as memory 712 and communications media. Computer storage media, such as memory 712, includes volatile and non-volatile, removable and non-removable media implemented in any method or technology for storage of information such as computer readable instructions, data structures, program modules or the like. Computer storage media includes, but is not limited to, random access memory (RAM), read only memory (ROM), erasable programmable read only memory (EPROM), electronic erasable programmable read only memory (EEPROM), flash memory or other memory technology, compact disc read only memory (CD-ROM), digital versatile disks (DVD) or other optical storage, magnetic cassettes, magnetic tape, magnetic disk storage or other magnetic storage devices, or any other non-transmission medium that is used to store information for access by a computing device. In contrast, communication media embody computer readable instructions, data structures, program modules, or the like in a modulated data signal, such as a carrier wave, or other transport mechanism. As defined herein, computer storage media does not include communication media. Therefore, a computer storage medium should not be interpreted to be a propagating signal per se. Although the computer storage media (memory 712) is shown within the computing-based device 700 it will be appreciated that the storage is, in some examples, distributed or located remotely and accessed via a network or other communication link (e.g. using communication interface 716).

The computing-based device has one or more capture devices 718 in some cases. It optionally has a display device 720 to display recognized actions and/or feedback.

Alternatively or in addition to the other examples described herein, examples include any combination of the following clauses

Clause A. An apparatus comprising:

at least one processor;
a memory storing instructions that, when executed by the at least one processor, perform a method for recognizing an action of a user, comprising:
accessing at least one stream of pose data derived from captured sensor data depicting the user;
sending the pose data to a machine learning system having been trained to recognize actions from pose data; and
receiving at least one recognized action from the machine learning system.

Clause B. The apparatus of clause A wherein the instructions, when executed by the at least one processor, perform a method comprising: accessing a plurality of streams of pose data derived from captured sensor data depicting the user; individual ones of the streams depicting an individual body part of the user.

Clause C. The apparatus of clause A or clause B wherein the instructions, when executed by the at least one processor, perform a method comprising: accessing a plurality of streams of pose data derived from captured sensor data depicting the user; individual ones of the streams having pose data specified in a coordinate system, and where the coordinate systems of the streams are different.

Clause D. The apparatus of any preceding clause wherein the instructions, when executed by the at least one processor, perform a method comprising, normalizing the plurality of streams of pose data by mapping the pose data into a common coordinate system. A common coordinate system is a coordinate system that is the same for each of the mapped posed data streams.

Clause E The apparatus of any preceding clause wherein the instructions, when executed by the at least one processor, perform a method comprising: normalizing the at least one stream of pose data by mapping the pose data from a first coordinate system to a common coordinate system.

Clause F The apparatus of any preceding clause wherein the instructions, when executed by the at least one processor, perform a method comprising, normalizing the at least one stream of pose data by mapping the pose data into a common coordinate system, and obtaining the common coordinate system from a remote entity having an address specified by a visual code obtained from sensor data depicting an environment of the user.

Clause G The apparatus of any of clauses A to E wherein the instructions, when executed by the at least one processor, perform a method comprising, normalizing the at least one stream of pose data by mapping the pose data into a common coordinate system, and obtaining the common coordinate system by accessing an object coordinate system of an object in an environment of the user.

Clause H The apparatus of any of clauses A to E wherein the instructions, when executed by the at least one processor, perform a method comprising, obtaining the common coordinate system by accessing an object coordinate system of an object in an environment of the user, the object coordinate system having been computed from sensor data depicting the object.

Clause I The apparatus of any preceding clause wherein the instructions, when executed by the at least one processor, perform a method comprising: responsive to criteria being met, activating a normalization process, for normalizing the at least one stream of pose data by mapping the pose data from a first coordinate system to a common coordinate system.

Clause J The apparatus of any preceding clause wherein the instructions, when executed by the at least one processor, perform a method comprising: assessing context data, and responsive to a result of the assessing, selecting the machine learning system from a plurality of machine learning systems, each of the machine learning systems having been trained to recognize different tasks.

Clause K The apparatus of any preceding clause comprising a wearable computing device, the wearable computing device having a plurality of capture devices capturing the sensor data when the wearable computing device is worn by the user, and wherein the wearable computing device computes the at least one stream of pose data.

Clause L The apparatus of any preceding clause wherein the at least one stream of pose data is hand pose data.

Clause M The apparatus of any of clauses A to K wherein the instructions, when executed by the at least one processor, perform a method comprising: accessing two streams of pose data derived from captured sensor data depicting the user, one of the streams being hand pose data and another of the streams being eye pose data.

Clause N The apparatus of any of clauses A to K wherein the instructions, when executed by the at least one processor, perform a method comprising: accessing two streams of pose data derived from captured sensor data depicting the user, one of the streams being hand pose data and another of the streams being head pose data.

Clause O The apparatus of any of clauses A to K wherein the instructions, when executed by the at least one processor, perform a method comprising: accessing three streams of pose data derived from captured sensor data depicting the user, one of the streams being hand pose data, another of the streams being head pose data, and another of the streams being eye pose data.

Clause P The apparatus of any preceding clause wherein the instructions, when executed by the at least one processor, perform a method comprising, responsive to the at least one recognized action doing one or more of: triggering an alert, displaying a corrective action, displaying a next action, giving feedback to the user about performance of the action.

Clause Q A computer-implemented method comprising:

accessing at least one stream of pose data derived from captured sensor data depicting a user;

sending the pose data to a machine learning system having been trained to recognize actions from pose data; and

receiving at least one recognized action from the machine learning system.

Clause R The method of clause Q comprising training the machine learning system using supervised training with a training data set comprising streams of pose data derived from sensor data depicting users carrying out actions of a single scenario, and, where individual frames of the pose data are labelled with one of a plurality of possible action labels of a scenario.

Clause S A computer-implemented method of training a machine learning system comprising:

accessing at least one stream of pose data derived from captured sensor data depicting a user, the stream of pose data being divided into frames, each frame having an action label from a plurality of possible action labels;

using supervised machine learning and the stream of pose data to train a machine learning classifier.

Clause T The method of clause S comprising, normalizing the pose data into a common coordinate system prior to the supervised machine learning.

The term ‘computer’ or ‘computing-based device’ is used herein to refer to any device with processing capability such that it executes instructions. Those skilled in the art will realize that such processing capabilities are incorporated into many different devices and therefore the terms ‘computer’ and ‘computing-based device’ each include personal computers (PCs), servers, mobile telephones (including smart phones), tablet computers, set-top boxes, media players, games consoles, personal digital assistants, wearable computers, and many other devices.

The methods described herein are performed, in some examples, by software in machine readable form on a tangible storage medium e.g. in the form of a computer program comprising computer program code means adapted to perform all the operations of one or more of the methods described herein when the program is run on a computer and where the computer program may be embodied on a computer readable medium. The software is suitable for execution on a parallel processor or a serial processor such that the method operations may be carried out in any suitable order, or simultaneously.

Those skilled in the art will realize that storage devices utilized to store program instructions are optionally distributed across a network. For example, a remote computer is able to store an example of the process described as software. A local or terminal computer is able to access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The operations of the methods described herein may be carried out in any suitable order, or simultaneously where appropriate. Additionally, individual blocks may be deleted from any of the methods without departing from the scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the scope of this specification.

What is claimed is:

1. An apparatus comprising:
at least one processor;
a memory storing instructions that, when executed by the at least one processor, perform a method for recognizing an action of a user, comprising:
accessing at least one stream of pose data derived from captured sensor data depicting the user;
sending the pose data to a machine learning system having been trained to recognize actions from pose data; and
receiving at least one recognized action from the machine learning system.

2. The apparatus of claim 1 wherein the instructions, when executed by the at least one processor, perform a method comprising: accessing a plurality of streams of pose data derived from captured sensor data depicting the user; individual ones of the streams depicting an individual body part of the user.

3. The apparatus of claim 1 wherein the instructions, when executed by the at least one processor, perform a method comprising: accessing a plurality of streams of pose data derived from captured sensor data depicting the user; individual ones of the streams having pose data specified in a coordinate system, and where the coordinate systems of the streams are different.

4. The apparatus of claim 1 wherein the instructions, when executed by the at least one processor, perform a method comprising, normalizing a plurality of streams of pose data at least by mapping the pose data into a common coordinate system.

5. The apparatus of claim 1 wherein the instructions, when executed by the at least one processor, perform a method comprising: normalizing the at least one stream of pose data at least by mapping the pose data from a first coordinate system to a common coordinate system.

6. The apparatus of claim 1 wherein the instructions, when executed by the at least one processor, perform a method comprising, normalizing the at least one stream of pose data at least by mapping the pose data into a common coordinate system, and obtaining the common coordinate system from a remote entity having an address specified by a visual code obtained from sensor data depicting an environment of the user.

7. The apparatus of claim 1 wherein the instructions, when executed by the at least one processor, perform a method comprising, normalizing the at least one stream of pose data at least by mapping the pose data into a common coordinate system, and obtaining the common coordinate system by accessing an object coordinate system of an object in an environment of the user.

8. The apparatus of claim 1 wherein the instructions, when executed by the at least one processor, perform a method comprising, obtaining a common coordinate system at least by accessing an object coordinate system of an object in an environment of the user, the object coordinate system having been computed from sensor data depicting the object.

9. The apparatus of claim 1 wherein the instructions, when executed by the at least one processor, perform a method comprising: responsive to criteria being met, activating a normalization process, for normalizing the at least one stream of pose data at least by mapping the pose data from a first coordinate system to a common coordinate system.

10. The apparatus of claim 1 wherein the instructions, when executed by the at least one processor, perform a method comprising: assessing context data, and responsive to a result of the assessing, selecting the machine learning system from a plurality of machine learning systems, each of the machine learning systems having been trained to recognize different tasks.

11. The apparatus of claim 1 comprising a wearable computing device, the wearable computing device having a plurality of capture devices capturing the sensor data when the wearable computing device is worn by the user, and wherein the wearable computing device computes the at least one stream of pose data.

12. The apparatus of claim 1 wherein the at least one stream of pose data is hand pose data.

13. The apparatus of claim 1 wherein the instructions, when executed by the at least one processor, perform a method comprising: accessing two streams of pose data derived from captured sensor data depicting the user, one of the streams being hand pose data and another of the streams being eye pose data.

14. The apparatus of claim 1 wherein the instructions, when executed by the at least one processor, perform a method comprising: accessing two streams of pose data derived from captured sensor data depicting the user, one of the streams being hand pose data and another of the streams being head pose data.

15. The apparatus of claim 1 wherein the instructions, when executed by the at least one processor, perform a method comprising: accessing three streams of pose data derived from captured sensor data depicting the user, one of the streams being hand pose data, another of the streams being head pose data, and another of the streams being eye pose data.

16. The apparatus of claim 1 wherein the instructions, when executed by the at least one processor, perform a method comprising, responsive to the at least one recognized action doing one or more of: triggering an alert, displaying a corrective action, displaying a next action, giving feedback to the user about performance of the action.

17. A computer-implemented method comprising:
accessing at least one stream of pose data derived from captured sensor data depicting a user;
sending the pose data to a machine learning system having been trained to recognize actions from pose data; and
receiving at least one recognized action from the machine learning system.

18. The method of claim 17 comprising training the machine learning system using supervised training with a training data set comprising streams of pose data derived from sensor data depicting users carrying out actions of a single scenario, and, where individual frames of the pose data are labelled with one of a plurality of possible action labels of a scenario.

19. A computer-implemented method of training a machine learning system comprising:
accessing at least one stream of pose data derived from captured sensor data depicting a user, the stream of pose data being divided into frames, each frame having an action label from a plurality of possible action labels; and
using supervised machine learning and the stream of pose data to train a machine learning classifier.

20. The method of claim 19 comprising, normalizing the pose data into a common coordinate system prior to the supervised machine learning.
